(19) United States
(12) Patent Application Publication
(10) Pub. No.: US 2012/0240382 A1
(43) Pub. Date: Sep. 27, 2012

(54) METHOD OF MACHINING A FAUCET

(76) Inventor: Miao-Lin LIN, Taichung City (TW)

(21) Appl. No.: 13/052,677

(22) Filed: Mar. 21, 2011

(51) Int. Cl. B23P 17/00

(52) U.S. Cl. 29/525.11

(57) ABSTRACT

A machining method of a pipe welding type mixing faucet, which has a transverse connecting tube, two switch control valve seats, two screwed pipes, a discharge pipe coupling seat, a discharge pipe and a housing made of stainless steel. Reduced abutting ring surfaces are separately fabricated into the discharge hole and bottom port of two switch control valve seats as well as the discharge through-hole of the transverse connecting tube, allowing for abutting of the transverse connecting tube, screwed pipe and discharge pipe coupling seat. The mating points are welded securely. With these machining methods, the pipe welding type mixing faucet allows for water flow through a stainless steel structure, thus improving sanitary quality and safety of potable water.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a mixing faucet, and more particularly to an innovative one which is configured into a pipe welding type via a machining method.

2. Description of Related Art Including Information Disclosed Under 37 CFR 1.97 and 37 CFR 1.98.

Conventional faucets are generally fabricated in such a simple way that the appearance and internal pipeline are integrally machined. Yet, it is found during actual applications that, due to sand holes and water leakage for the machined structure, poisonous lead will be gradually released from the sand holes, resulting in contamination of water and ambient environment as well as damage to human health. For the developed countries in Europe and America where potable tap water is available to any individuals, the structural design of the faucet is of great importance.

In particular, when the flow channel of dual-temperature mixing faucet is provided with hot water, lead is released more quickly, causing more serious pollution.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The present invention is mainly characterized by that, the transverse connecting tube, switch control valve seat, screwed pipe, discharge pipe coupling seat and discharge pipe are made of stainless steel. With this unique configuration, the present invention enables one to improve the sanitary quality and safety of potable water since water flows through the stainless steel structure, thus preventing efficiently water contamination with much better performance.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled perspective view of the preferred embodiment of the present invention.

FIG. 2 is an exploded perspective view of the preferred embodiment of the present invention.

FIG. 3 is a partially exploded view of the preferred embodiment of the present invention.

FIG. 4 is a machining process chart of some parts of the present invention.

FIG. 5 is a partial view of the welding points in the preferred embodiment of the present invention.

FIG. 6 is a first schematic view of another preferred embodiment of the present invention.

FIG. 7 is a second schematic view of another preferred embodiment of the present invention.

FIG. 8 is a variation chart of the transverse connecting tube of the present invention.

### DETAILED DESCRIPTION OF THE INVENTION

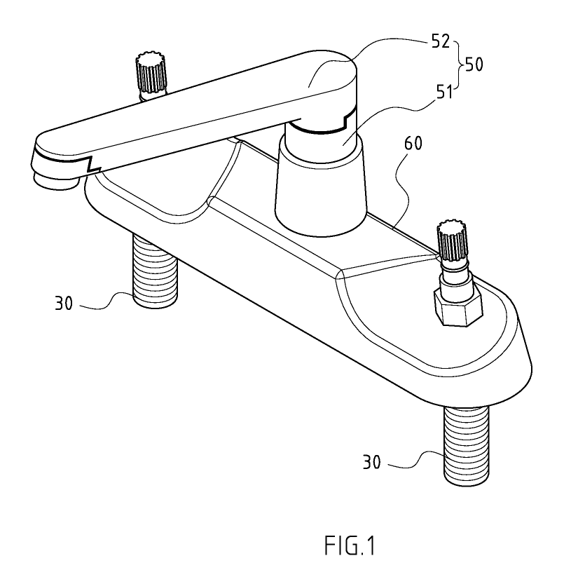

FIGS. 1-3 depict preferred embodiments of the machining method of a pipe welding type mixing faucet of the present invention, which, however, are provided for only explanatory objective for patent claims.

Said machining method of the pipe welding type mixing faucet covers: a transverse connecting tube 10, two switch control valve seats 20, two screwed pipes 30, a discharge pipe coupling seat 40, a discharge pipe 50 and a housing 60. Said transverse connecting tube 10, switch control valve seats 20, screwed pipe 30, discharge pipe coupling seat 40 and discharge pipe 50 are made of stainless steel.

Of which, two switch control valve seats 20 are fitted vertically with a water control valve spool assembly slot 21 for assembly of the water control valve spool 22. A discharge hole 23 is set correspondingly to these two switch control valve seats 20 for mating with two ends of the transverse connecting tube 10. Moreover, the bottom port 24 of these two switch control valve seats 20 is separately mated with the top of two screwed pipes 30. A discharge through-hole 11 is set at top center of the transverse connecting tube 10 for mating with the discharge pipe coupling seat 40. A discharge pipe mating portion 41 is set at top of the discharge pipe coupling seat 40 for mating with the discharge pipe 50. The discharge pipe 50 has a riser pipe 51 and a discharge portion 52 protruded obliquely or transversely from the riser pipe 51. The housing 60 is provided with a central through-hole 61 and two lateral through-holes 62.

Reduced abutting ring surfaces 71, 72, 73 are separately fabricated into the discharge hole 23 and bottom port 24 of two switch control valve seats 20 as well as the discharge through-hole 11 of the transverse connecting tube 10.

The machining method of said pipe welding type mixing faucet includes the following steps:

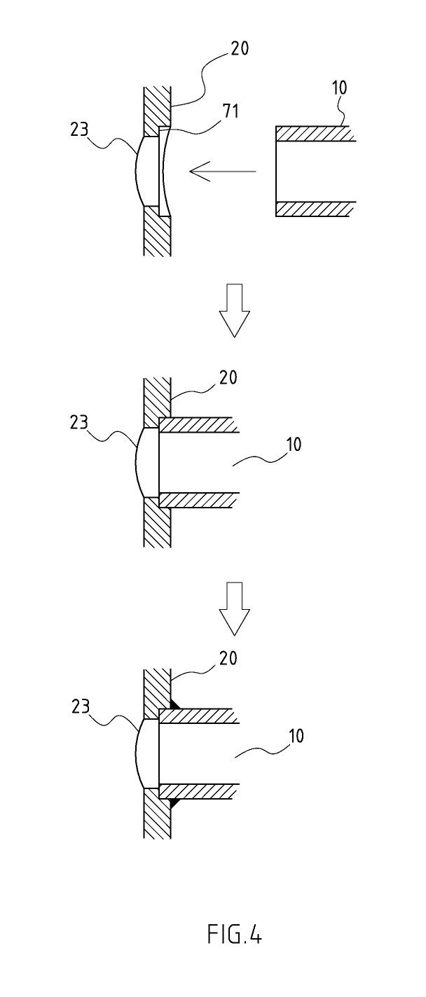

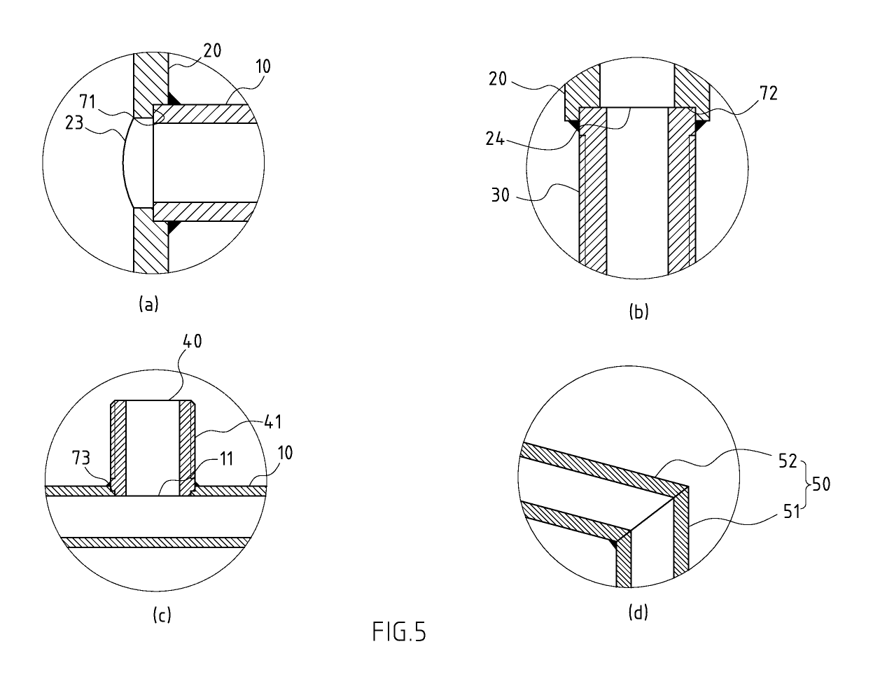

(i) both ends of the transverse connecting tube 10 are separately inserted into the discharge hole 23 of two switch control valve seats 20, and abutted onto the abutting ring surface 71 in the discharge hole 23; then, the exteriors of both ends of the transverse connecting tube 10 and the outer ends of the discharge hole 23 are welded (in collaboration with FIG. 4), such that the transverse connecting tube 10 and two switch control valve seats 20 are coupled securely (disclosed in FIG. 5(a));

(ii) the top of two screwed pipes 30 is separately inserted into the bottom port 24 of two switch control valve seats 20, and abutted onto the abutting ring surface 72 in the bottom port 24; then, the exterior of the top of the screwed pipe 30 and the bottom port 24 of the switch control valve seats 20 are welded, such that two screwed pipes 30 and two switch control valve seats 20 are coupled securely(disclosed in FIG. (b));

(iii) the bottom of the discharge pipe coupling seat 40 is inserted into the discharge through-hole 11 of the transverse connecting tube 10, and abutted onto the abutting ring surface 73 in the discharge through-hole 11; then, the exterior of the bottom of the discharge pipe coupling seat 40 and the outer end of the discharge through-hole 11 are welded, such that the discharge pipe coupling seat 40 and transverse connecting tube 10 are coupled securely (disclosed in FIG. 5(c));

(iv) assemble and position the water control valve spool 22 using water control valve spool assembly slot 21 of two switch control valve seats 20;

(v) the central through-hole 61 of the housing 60 is sleeved onto the periphery of the discharge pipe coupling seat 40, such that the discharge pipe coupling seat 40 is protruded out of the housing 60; two lateral through-holes 62 of the housing 60 are sleeved onto the periphery of the valve rod of the water control valve spool 22, and then fixed by a locator (e.g. screw bolt); and

(vi) the discharge pipe 50 is mated with the discharge pipe mating portion 41 on the top of the discharge pipe coupling seat 40; said discharge pipe mating portion 41 is a male screwed portion.

With these steps, the pipe welding type mixing faucet is machined to improve the sanitary quality and safety of potable water due to stainless steel structure.

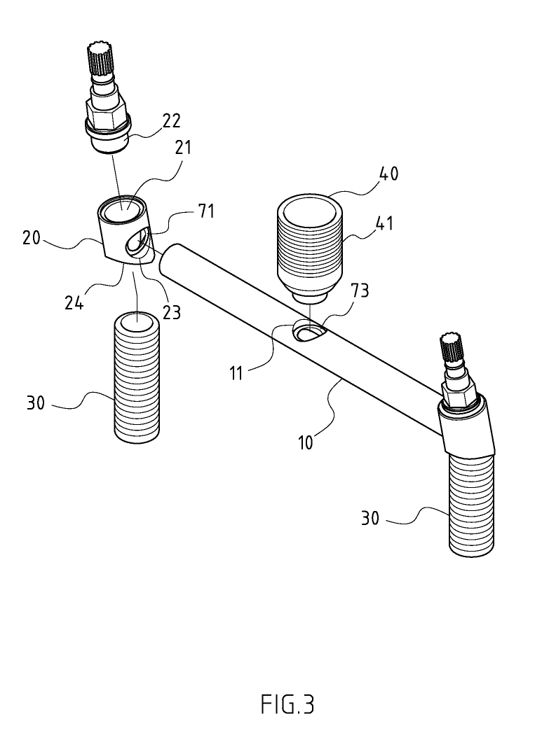

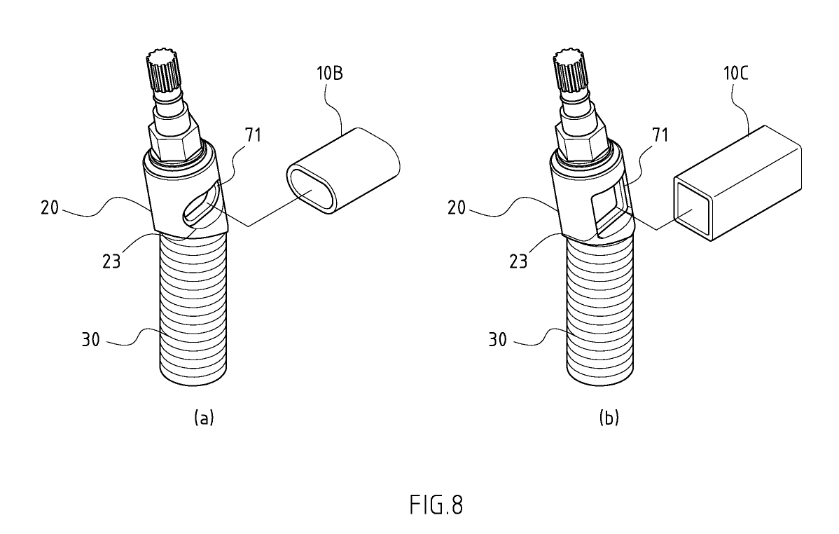

Of which, said transverse connecting tube 10 is available with several cross sections. Referring to FIG. 3, the transverse connecting tube 10 is configured into a round pattern, or referring to FIG. 8(a), (b), the transverse connecting tubes 10B, 10C are separately configured into an oblong or rectangular shape, and the discharge hole 23 of the switch control valve seat 20 is mated with the transverse connecting tubes 10, 10B, 10C.

Of which, the riser pipe 51 and discharge portion 52 of the discharge pipe 50 are butt-jointed in a foldable state, and also welded securely at the folding point (as disclosed in FIG. 5(d)).

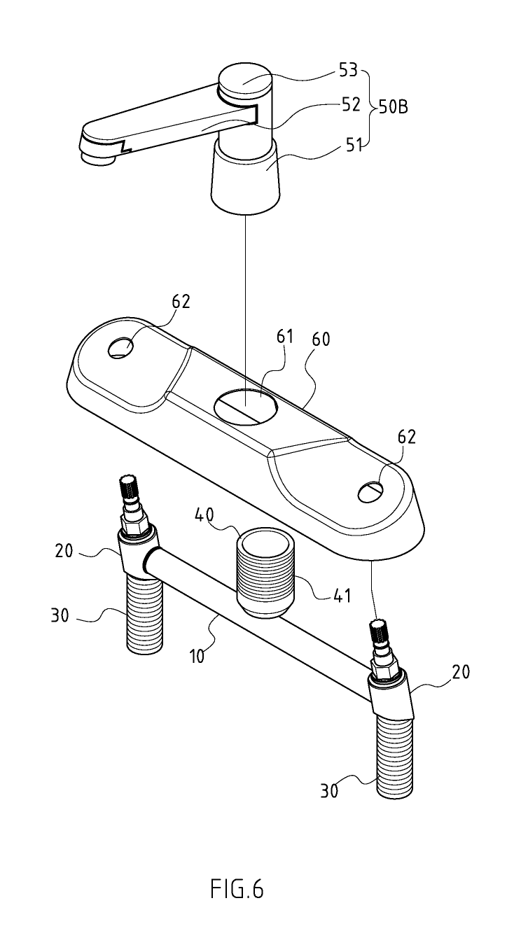

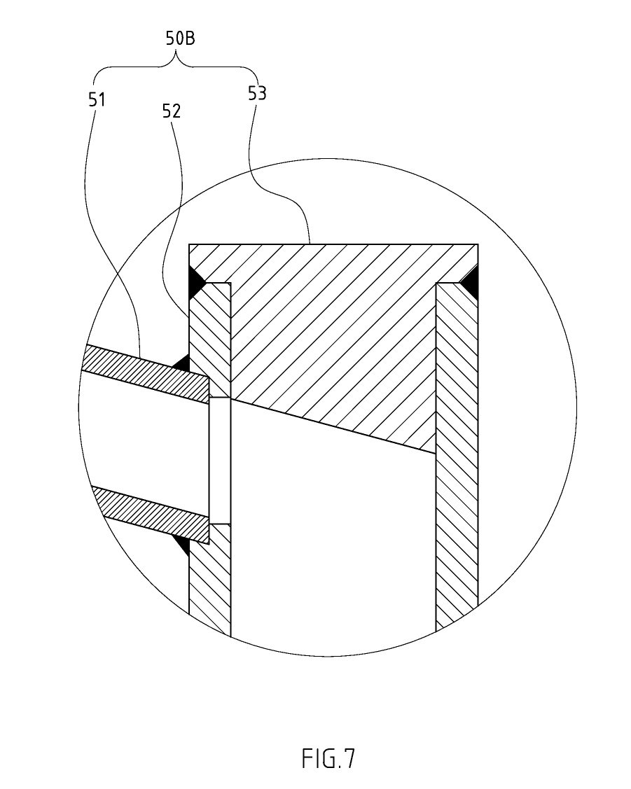

Referring to FIGS. 6 and 7, an end cap 53 is further set at the top of the riser pipe 51 of the discharge pipe 50B, while the assembly portion of the discharge portion 52 and riser pipe 51 is welded securely to improve greatly the robustness of the discharge pipe 50B.

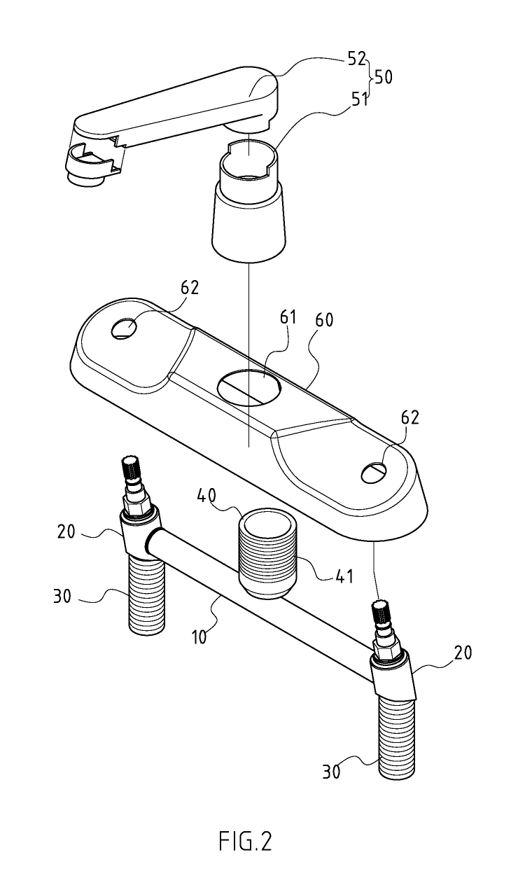

Of which, the discharge pipe coupling seat 40 and discharge pipe 50 are welded into a fixed pattern or screwed into a combined pattern with male and female screws (as disclosed in FIG. 2).

Based on above-specified structural configuration, the present invention is operated as follows:

Common cold/hot water inlet tubes are set separately at bottom of two screwed pipes 30. When cold/hot water switch control valve seats 20 are opened, cold/hot water flows through the transverse connecting tube 10 into a mixed state, and then flows out of the discharge pipe 50 through the discharge pipe coupling seat 40 for mixed water supply.

The core feature of the pipe welding type mixing faucet of the present invention lies in that, said transverse connecting tube 10, switch control valve seat 20, screwed pipe 30, discharge pipe coupling seat 40 and discharge pipe 50 are made of stainless steel, so the pipe welding type mixing faucet can be machined to improve the sanitary quality and safety of potable water, preventing efficiently water contamination with much better performance.

1. A machining method of pipe welding type mixing faucet comprising
a transverse connecting tube, two switch control valve seats, two screwed pipes, a discharge pipe coupling seat, a discharge pipe and a housing; said transverse connecting tube, switch control valve seat, screwed pipe, discharge pipe coupling seat and discharge pipe are made of stainless steel;
of which, two switch control valve seats are fitted vertically with a water control valve spool assembly slot for assembly of the water control valve spool; a discharge hole is set correspondingly to these two switch control valve seats for mating with two ends of the transverse connecting tube; moreover, the bottom port of these two switch control valve seats is separately mated with the top of two screwed pipes; a discharge through-hole is set at top center of the transverse connecting tube for mating with the discharge pipe coupling seat; a discharge pipe mating portion is set at top of the discharge pipe coupling seat for mating with the discharge pipe; the discharge pipe includes a riser pipe and a discharge portion protruded obliquely or transversely from the riser pipe; the housing is provided with a central through-hole and two lateral through-holes;
reduced abutting ring surfaces are separately fabricated into the discharge hole and bottom port of two switch control valve seats as well as the discharge through-hole of the transverse connecting tube;
both ends of the transverse connecting tube are separately inserted into the discharge hole of two switch control valve seats, and abutted onto the abutting ring surface in the discharge hole; then, the exteriors of both ends of the transverse connecting tube and the outer ends of the discharge hole are welded, such that the transverse connecting tube and two switch control valve seats are coupled securely;
the top of two screwed pipes is separately inserted into the bottom port of two switch control valve seats, and abutted onto the abutting ring surface in the bottom port; then, the exterior of the top of the screwed pipe and the bottom port of the switch control valve seats are welded, such that two screwed pipes and two switch control valve seats are coupled securely;
the bottom of the discharge pipe coupling seat is inserted into the discharge through-hole of the transverse connecting tube, and abutted onto the abutting ring surface in the discharge through-hole; then, the exterior of the bottom of the discharge pipe coupling seat and the outer end of the discharge through-hole are welded, such that the discharge pipe coupling seat and transverse connecting tube are coupled securely;
the water control valve spool is assembled and positioned by using water control valve spool assembly slot of two switch control valve seats;
the central through-hole of the housing is sleeved onto the periphery of the discharge pipe coupling seat, such that the discharge pipe coupling seat is protruded out of the housing; two lateral through-holes of the housing are sleeved onto the periphery of the valve rod of the water control valve spool, and then fixed by a locator;
the discharge pipe is mated with the discharge pipe mating portion on the top of the discharge pipe coupling seat;
the pipe welding type mixing faucet is machined to improve the sanitary quality and safety of potable water due to stainless steel structure.

2. The method defined in claim 1, wherein said transverse connecting tube is available with round, oblong or rectangular cross sections: and the discharge hole of the switch control valve seat is mated with the transverse connecting tubes.

3. The method defined in claim 1, wherein the riser pipe and discharge portion of the discharge pipe for the discharge pipe mating portion are butt-jointed in a foldable state, and also welded securely at the folding point.

4. The method defined in claim 1, wherein an end cap is further set at the top of the riser pipe of the discharge pipe for the discharge pipe mating portion, while the assembly portion of the discharge portion and riser pipe is welded securely.

5. The method defined in claim 1, wherein the discharge pipe coupling seat and discharge pipe are welded into a fixed pattern or screwed into a combined pattern with male and female screws.
